(19) United States
(12) Patent Application Publication
(10) Pub. No.: US 2025/0036498 A1
(43) Pub. Date: Jan. 30, 2025

(54) AUTOMATED PERFORMANCE TESTING IN A CONTAINERIZED ENVIRONMENT

(71) Applicant: MASTERCARD INTERNATIONAL INCORPORATED, Purchase, NY (US)

(72) Inventors: Adegboyega Paul ADEYENUWO, East Meadow, NY (US); Hemant Prakash BHANUSHALI, Brooklyn, NY (US); Samuel GEDALY, Aventura, FL (US); Jose RODRIGUEZ, Bay Shore, NY (US); Phaneendra Goutham BATTHALA, Carteret, NJ (US)

(73) Assignee: MASTERCARD INTERNATIONAL INCORPORATED, Purchase, NY (US)

(21) Appl. No.: 18/783,612

(22) Filed: Jul. 25, 2024

Related U.S. Application Data
(60) Provisional application No. 63/529,103, filed on Jul. 26, 2023.

(51) Int. Cl. G06F 11/00

(52) U.S. Cl. CPC G06F 11/004; G06F 2201/805

(57) ABSTRACT

The disclosure relates to systems and methods for automated performance testing in a containerized environment. For example, a system may invoke one or more PTSs (PTSs) that each manage a respective type of performance test, such as a load test, a stress test, and a soak test. Each PTS may instantiate one or more dynamic clusters in a container to execute performance test scripts that execute operations to conduct the performance test. The PTS may estimate a testing capacity of each dynamic cluster so that the load during testing does not exceed those limits. The dynamic clusters may perform client-side load balancing that approximates real-world load profiles to more accurately simulate real-world loads based on user behaviors that would occur throughout a test session. The system may use logging and metrics from a diverse set of services that monitor target systems during the automated performance test.

### CROSS-REFERENCE TO RELATED APPLICATIONS

This application claims the benefit of priority of U.S. Provisional Application No. 63/529,103, filed on Jul. 26, 2023, which is incorporated by reference in its entirety herein for all purposes.

### BACKGROUND

Computer systems may execute various services and applications over a network. The complexity and scale of the services and applications may impose computational loads on the underlying infrastructure that may cause failure, latencies, or other problems. Furthermore, changes to the services and applications, such as bug fixes, enhancements, or updates may cause unexpected behaviors of these services and applications. Changes to the underlying infrastructure such as configuration updates, hardware updates, software updates, or other changes may also cause unexpected behaviors. Service life or other failure conditions with the underlying infrastructure may further cause downtimes and unexpected behaviors. To mitigate these and other problems, performance testing may be conducted on the underlying infrastructure. However, such testing may be specific to the technology stacks employed by tested systems, which may make testing unreliable.

Furthermore, various testing may not reflect real-world conditions, such as differences in how a given user interacts with the services and applications, making it difficult to anticipate the duration of loads that will be imposed by the use of a given service or application. Another issue with performance testing is that the tests may create an over-capacity of underlying infrastructure, which may result in test failure and wasted computational time and resources to execute the failed tests. Yet another issue with performance testing is that it may be difficult to properly assess whether the underlying test performed satisfactorily during a given performance test.

These and other issues will continue to grow as services, applications, and underlying infrastructure continue to grow in size and complexity.

### BRIEF DESCRIPTION OF THE DRAWINGS

Features of the present disclosure may be illustrated by way of example and not limited in the following figure(s), in which like numerals indicate like elements, in which:

FIG. 1 illustrates an example of a system of performance orchestration for automated performance testing based on a containerized computing architecture of a runtime environment;

FIG. 2 illustrates an example of a method of performing automated performance testing in the system illustrated in FIG. 1;

FIG. 3 illustrates an example of a method of client-side load balancing;

FIG. 4 illustrates an example method of determining a testing capacity of dynamic clusters to prevent or reduce performance testing over-capacity;

FIG. 5 illustrates an example of a data flow of an SLI/SLO subsystem for analyzing and determining the quality of the results of a performance test;

FIG. 6 illustrates an example of a method of automated performance testing; and

FIG. 7 illustrates an example of a computer system that may implement the various features of FIGS. 1-6.

### DETAILED DESCRIPTION

The disclosure herein relates to methods and systems of performance orchestration for automated performance testing based on a containerized computing architecture. The automated performance testing described herein may address various issues with automated performance testing. In particular, the automated performance testing described herein may address various issues with automated performance testing that arise in the context of one or more non-functional characteristics and/or requirements. A non-functional characteristic is a description of how a computational system such as hardware and/or software performs a task. For example, a non-functional characteristic may include a description of an amount of time the computational system takes to perform the task, a number of concurrent tasks the computational system is capable of performing, and/or other characteristics that specify how the computational system is able to perform the task. A non-functional requirement is a description of how a computational system should perform the task. For example, a non-functional requirement may include a description of a computational load the computational system should be able to handle, a maximus usage over time the computational system should be able to perform, a typical production load over a continuous availability period that the computational system should be able to handle, and/or other characteristics that specify how the computational system should perform a given task.

Objectively determining the non-functional characteristics of a computational system is an important concern. However, simple performance tests such as those that are based on test scripts that hard-code evaluations of performance may be insufficient to test large-scale platforms or software products with multiple (such as hundreds of) microservices and/endpoints. This is because simple tests are inflexible and unable to adapt to performance testing that reflects real-world execution of a product or platform under live conditions. For example, simple testing may not adequately account for real-world parameters such as active users and duration that may vary over time, geography, or intended scenarios such as load, stress, soak, and/or other type of testing.

Testing these and other scenarios in such manner may not be efficient, time and/or cost effective to create and maintain a set of test scripts that can reflect all the possible combinations of scenarios that a computational system will experience under live conditions. Modern software platforms may be deployed across several geographics and varying infrastructure such as across virtual machines, physical boxes, containerized applications, and so forth. These platforms may operate under varying network conditions at different times and may not be testable with manually curated strategies and/or may require duplicative efforts by large teams. Thus, testing non-functional requirements on computational systems that serve multiple (such as millions of) concurrent users in multiple geographies may be difficult using simple tests.

Furthermore, the intricacies of performance testing need to consider several additional details including how to ensure users and the interaction durations reflect actual use. For example, an e-commerce software application may include an arbitrary number of steps (such as 5) to complete a purchase: register or login to the application, find the product, add it to cart, review list of items in a checkout screen, and complete checkout by making a purchase. Modern applications which are usually multi-tier systems or microservices may break down each of these steps into several microservice applications or internal calls supported by external systems. Assuming at some initial time t=0, there is a certain number n=1000 of users. At every point in each of step of k, there is a very high probability that one or more users out of n (i.e. 1000) will abandon the purchase process, suspend usage or wait too long on a step and is automatically signed out (removed) and must start the process all over in a new session. Accurately testing the e-commerce platform in the manner described may involve manually creating a testing script for each possible scenario which may include different geographies, specific time periods of activity such as a holiday (in which user behaviors may be different than at other times), and/or other variable factors.

To address testing dependencies based on diverse technology stacks that may be used by different tested systems, an architecture of a performance orchestration environment may use performance test services (PTSs) that may include multi-component microservices. The PTSs may implement a common runtime core for the various aspects and types of performance tests. This architecture instantiates flexible and scalable runtime environments that may be customized for various tested systems and be agnostic to any particular testing programs.

For example, each PTS may instantiate one or more dynamic clusters in a container to execute performance test scripts that execute operations to conduct the performance test (interchangeably referred to herein as an automated performance test). To address over-capacity problems, the PTS may estimate a testing capacity (such as a load capacity) of each dynamic cluster so that the load during testing does not exceed those limits. To address problems of real-world loads, the dynamic clusters may perform client-side load balancing that approximates real-world load profiles to more accurately simulate real-world loads based on user behaviors that would occur throughout a test session. To address the problem of assessing test results, the system may use logging and metrics from a diverse set of services that monitor target systems during the automated performance test. The system may aggregate the logs and metrics to determine service level indicators (SLIs) to compare them against service level objectives (SLOs).

Having described a brief description of examples of the methods and systems described herein, attention will now turn to an example of a system that facilitates automated performance testing pipelines.

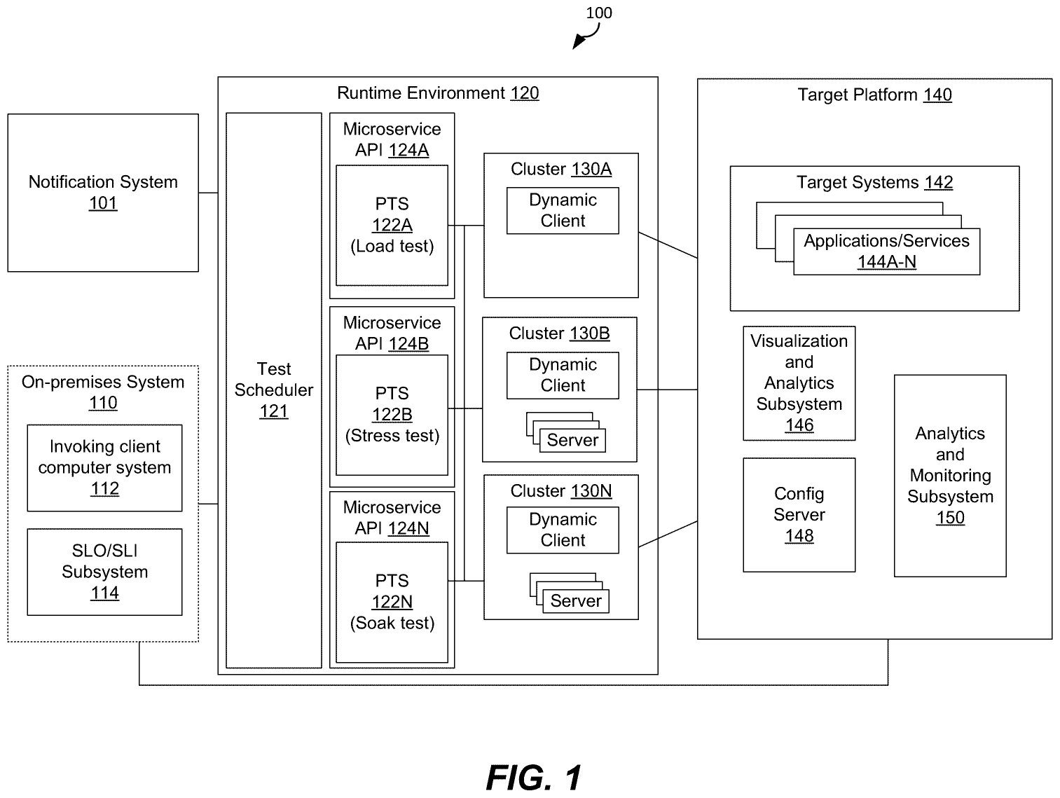

For example, FIG. 1 illustrates an example of a system 100 of performance orchestration for automated performance testing based on a containerized computing architecture of a runtime environment 120. The system 100 may include a notification system 101, an on-premises computer system 110, a runtime environment 120, a target platform 140, and/or other features. The notification system 101 may transmit messages between various components of the system 100. For example, the notification system 101 may transmit instant messaging between the invoking client computer system 112 and components of the runtime environment 120.

The on-premises computer system 110 may include an invoking client computer system 112, a service level objective and service level indicator (SLO/SLI) subsystem 114, and/or other features. The invoking client computer system 112 may include an automation process that invokes an automated performance test. The invocation may be made via a performance testing API call to one or more PTSs 122. The automation process may include a client, a pipeline process, a user, an application, a script, and/or other process that can initiate the automated performance test. The SLO/SLI process may define service level objectives of a target platform 140 and assess service level indicators based on the automated performance test to determine compliance with the service level objectives. It should be noted that the invoking client computer system 112 and the SLO/SLI subsystem 114 are illustrated as being within an on-premises computer system 110 for convenience. The invoking client computer system 112 and the SLO/SLI subsystem 114 may not be co-located and may be housed or otherwise be executed separately.

The runtime environment 120 is a computational environment in which test components will be executed to run the automated performance tests. The runtime environment 120 may include hardware, software, configuration data, and/or other assets that may be used for executing the automated performance test. In some examples, the runtime environment 120 may implement a containerized architecture. A containerized architecture may refer to the execution of one or more applications within a container.

A container refers to an isolated environment that includes one or more applications and their dependencies so that the container includes all assets that may be needed to execute the one or more applications. A dependency may refer to software, hardware, data, and/or other computational asset that may be required by an application to execute. A container bundles the one or more applications and dependencies into a standard unit, which may be referred to as a container image. The container image is therefore self-contained, isolating the one or more applications from the runtime environment. Such isolation permits the one or more applications to run across different technology stacks or computing environments. Each container may execute on a node. A node may be a physical machine (hardware such as a processor) or a virtual machine (self-contained software that executes applications). A node may be grouped with other nodes into a cluster.

As illustrated in FIG. 1, the runtime environment 120 may include one or more PTSs 122 (illustrated as PTSs 122A, 122B, . . . , 122N) that generate one or more dynamic clusters 130 (illustrated as dynamic clusters 130A, 130B, . . . , 130N) to initiate a performance test. Each PTS 122 may initiate a type of performance test. For example, PTS 122A may initiate a load test, PTS 122B may initiate a stress test, and PTS 122N may initiate a soak test. Other PTSs 122 may execute other types of tests as well or instead. A load test may analyze the performance capabilities of the target systems 142 by subjecting them to a specified load over a certain period of time. A stress test may analyze the performance capabilities of the target systems 142 by subjecting them to maximum usage over a certain period of time such as higher than an expected duration of time of actual use. A soak test may analyze the performance capabilities of the target systems 142 by subjecting them to a load that the target systems 142 were designed to handle or otherwise are expected to handle. The soak test is designed to detect performance-related issues such as stability and response time.

A PTS 122 (also referred to as a PTS 122A, PTS 122B, or PTS 122N) is a computational process for executing instructions for initiating an automated performance test. In some examples, a PTS 122 may be implemented as a microservice. A microservice refers to an independently deployable unit of code. A microservice may communicate through well-defined Application Programming Interfaces (APIs). In some examples, a PTS 122 may be invoked via a corresponding performance testing Application Programming Interface (API) 124 (illustrated as performance testing API 124). Each performance testing API 124 may expose API calls that invoking client computer systems 112 may use to interact with a corresponding PTS 122. For examples, an invoking client computer system 112 may make a performance testing API call to the performance testing API 124A to invoke the PTS 122A. The performance testing API 124A may transmit data back to the invoking client computer system 112 to communicate results or other data relating to the performance test.

A performance test component (PTC) 122 may be agnostic of particular performance testing tools, such as JMETER, GATLING, or others. For example, each PTS 122 may be included with different set of components, container images that include the test environment runtime executable and tools, dependencies, plugins, and configurations to support their functionality in the runtime environment 120. Thus, each PTS 122 may be integrated within the runtime environment 120 in which the automated performance tests are to be conducted, which may provide cross-platform and testing tool agnostic behavior.

In some examples, performance test instructions, such as performance test scripts, may be integrated with a performance testing tool such as JMETER, GATLING, and so forth. The performance test instructions may include logic that encodes processes or transactions to be performed in connection with an automated performance test. The performance test instructions may be stored in a code repository. To guarantee high performance of the performance orchestration environment, a highly available configuration server (such as the config server 148), hosting a dedicated source control repository may be deployed within network proximity to the performance orchestration environment and continually synchronizes the latest versions of performance test scripts and configurations pushed from an external shared repository, for fast and reliable access.

A dynamic cluster 130 is a self-contained runtime environment that includes the necessary computational assets to execute an automated performance test. In some examples, the PTS 122 may instantiate the dynamic cluster 130 as a container. In these examples, the PTS 122 may use a base container image that includes base assets that may be commonly needed to run any type of automated performance test. The PTS may then layer the base container image with additional assets used in the automated performance test. The additional assets may include configurations, scripts, and/or other assets needed to run a particular type of automated performance test that is initiated by the invoking client computer system 112. In this way, the dynamic cluster 130 may be configured as specialized containers that can function as test clients and/or test servers for executing the automated performance test. For simple and small loads (virtual users), a single containerized test client may be instantiated but for larger and more complex scenarios, a larger cluster environment may be generated by the performance test components 122.

The target platform 140 is an off-premises or on-premises computer system that is to be tested. The target platform 140 may include one or more target systems 142, a visualization and analytics subsystem 146, a configuration (illustrated as “config”) server 148, an analytics and monitoring subsystem 150, and/or other features. The one or more target systems 142 may include physical or virtual computers that host one or more applications or services 144A-N. The visualization and analytics subsystem 146 may monitor performance of the target system 142 during performance testing and/or non-testing activity in which the target system 142 executes applications and services 144A-N. The configuration (illustrated as “config”) server 148 may store and provide various configurations that are used in the target system 142. The analytics and monitoring subsystem 150 may include loggers and metrics monitors that observe performance of the target systems 142.

### Invoking an Automated Performance Test

At 202, the invoking client computer system 112 may transmit a performance test request to perform an automated performance test. For instance, the invoking client computer system 112 may initiate each type of performance test to be conducted by individually invoking corresponding PTS 122. Invoking as used herein may refer to transmitting a request to a service to initiate a performance test. The invoking client computer system 112 may invoke the PTS 122 by transmitting a performance test request to a specific PTS 122 and/or through a performance testing API call to a performance testing API 124.

The test initiation request may include a required payload for running the automated performance test. The payload may include or identify a data model. The data model may include configuration setup information, test parameters, and/or other data. The configuration setup information may identify the location of the performance test script in a storage such as a source control repository. The performance test script may include one or more performance tests, configurations, pre-processing steps, post-processing steps, and/or other instructions that are to be executed for the performance test. The test parameters may include the load (number of virtual users), duration, expected payload size, and/or other test metadata used to setup the test environment. The test parameters may be packaged into a command line invocation, which initiates the specific PTS and begins its process.

### Expressly Identifying PTSs to Invoke

In some examples, the invoking client computer system 112 may include a pre-invocation pipeline that schedules each type of test with a corresponding PTS 122. In one of these examples, the pre-invocation pipeline may determine that a load test should be conducted and identify the PTS 122A that corresponds to the load test. In another one of these examples, the pre-invocation pipeline may determine that a stress test should be conducted and identify the PTS 122B that corresponds to the stress test. The pre-invocation pipeline may schedule other PTSs 122 as well or instead. The foregoing pre-invocation may provide a streamlined and efficient way to identify and schedule different types of tests to be initiated by a corresponding PTS 122.

### Identifying PTSs to Invoke Based on Invocation Context

In some examples, the system may automatically identify the PTS 122 based on an invocation from the invoking client computer system 112 without the client expressly identifying a specific PTS 122. For example, a test scheduler 121 in the runtime environment 120 may automatically determine an intent of the invocation and match the intent with a functionality of a performance test handled by a PTS 122.

To determine the intent, the test scheduler 121 may access the test parameters from the invocation and determine an appropriateness of a performance test for those test parameters. For example, the test scheduler 121 may determine that one or more test parameters such as the load (number of virtual users), duration, expected payload size, and/or other test metadata may correspond to a load test and determine that the PTS 122A should be invoked.

In some examples, the test scheduler 121 may learn from and improve its test selection behavior by invoking the SLO/SLI subsystem 114 to understand historical test patterns and data, and use this data to improve its decisioning and scheduling process. For example, the test scheduler 121 may correlate one or more of the test parameters (and their parameter values) with automated performance tests and corresponding PTSs 122 that were historically executed.

In some examples, the test scheduler 121 may operate within a PTSs 122. For example, if the PTS 122A (executing a load test) receives a load test request having an intent matching that of a stress test, the PTS 122A (executing the test scheduler 121) may transmit the performance test requirement to the PTS 122B that executes a stress test without additional interactions from the invoking client computer system 112. In this example, the PTS 122A transmits the invocation to the PTS 122B, which initializes the stress test.

### Testing Setup

When the performance test API receives the performance test request, it analyzes it and begins the process of setting-up and configuring the server-side load generation cluster or environment that can support the expected load, duration, test-data generation, payload size, etc. requirements of the performance test. Initially, we start on an assumed load (number of virtual users) that can be supported by each client or server instance in the cluster, which may be provided by open-source software tools documentation, e.g., JMeter. However, since there can be a significant variation in the specifications, capabilities and performance of the underlying infrastructure, a series of tests were used to validate the optimal configurations for supporting a test requiring a specific number of users.

At 204, a PTS 122 may receive a performance test request (whether the PTS 122 is expressly identified or automatically identified based on context) and determine an initial dynamic cluster size for the performance test. The PTS 122 initial cluster size based on one or more of the test parameters. For example, higher loads may require larger or more complex dynamic clusters.

At 206, after computing an initial cluster size for the performance test, the PTS 122 may instantiate one or more dynamic clusters 130 based on the initial cluster size. For example, the PTS 122 may generate instructions to an underlying orchestration platform, to setup the one or more dynamic clusters 130. As previously noted, a dynamic cluster 130 may include a single client instance (such as illustrated by dynamic cluster 130A), or a cluster of client and server instances (such as illustrated by dynamic cluster 130B and 130N) depending on the initial cluster size. The orchestration platform may refer to a computational platform that coordinates execution of the runtime environment 120. For example, in a containerized architecture, the orchestration platform may coordinate the activities of each container. As illustrated in FIG. 1, for example, the orchestration platform may instantiate, based on the instructions from the PTS 122, each dynamic cluster 130, which may be containers executed and coordinated by the orchestration platform. An example of an orchestration platform is the KUBERNETES platform, although other orchestration platforms may be used.

At 208, when the initial dynamic cluster setup is complete, the PTS 122 communicates with each of the one or more dynamic clusters 130 to inspect and validate that each match the expected cluster setup. The validation may include executing connectivity and resource checks within the dynamic cluster sub-network. In some examples, the initial cluster size may be over-provisioned to tolerate and anticipate faults that may occur during validation. Thus, if any instance in any one of the dynamic clusters 130 fails pre-flight validation, that dynamic cluster may be automatically excluded from executing the performance tests. In this instance, the final cluster size may be smaller than the initial cluster size. Depending on the final cluster size, the PTS 122 may re-calculate the load to be applied to each cluster instance that remains and updates the configurations to be passed to the client-side performance test script component. Each component (dynamic client and/or dynamic server) in each dynamic cluster 130 individually initializes, based on its role and configurations, and attains a stable state, including ensuring that each dynamic server instance is bound to a dynamic client and is reachable via its internal network, communicates with the hosted configuration server to retrieve current configurations and begin the execution of the performance test.

At 210, the PTS 122 invokes the dynamic client in each of the one or more dynamic clusters 130 and provides the dynamic client with a payload, which is used to initially parameterize the performance test script data model and start its execution. The performance test script executes concurrently on each dynamic cluster 130. Each dynamic cluster 130 will retrieve the same performance test script and configurations as other ones of the dynamic clusters 130.

At 212, each dynamic cluster 130 executes one or more processing operations defined by the performance test script. Execution of the performance test script generates the load applied to the target systems 142. For example, the performance test script may simulate a number of users corresponding to the load specified by the test parameters to test how the target systems 142 perform under that load. Other types of tests may be conducted as well. The target systems 142 may include services or applications executing on various types of on-premises or off-premises infrastructure, such as cloud, virtual machines and/or physical machines. The performance test script may be designed to model data compatible with the orchestration system and has the capability to hook back into the invoking PTS 122 during its setup and initialization to execute pre-processing and post-processing steps. In examples in which the dynamic cluster includes a dynamic client and a dynamic service in a client-server instance, the dynamic client coordinates the results of the performance tests executed by the server instances and the performance data persisted in a time series database of the visualization and analytics subsystem 146.

At 214, these results may be analyzed and visualized by the visualization and analytics subsystem 146. Errors and other information may be retrieved and streamed to the dynamic client. At 216, if early termination due to errors is necessary, the invoking client computer system 112 may kill the process that initiated the automated performance test, which sends the appropriate messages via the notification system 101 to the PTS 122 to terminate the automated performance test. At 218, the PTS 122 may terminate the automated performance test and remove the dynamic clusters 130 and other assets in the runtime environment 120 that were set up for the automated performance test. In some examples, the dynamic clusters 130 may be configured to be cleaned-up (removed) automatically within a specified time. When performance testing is complete, control may return to the invoking client computer system 112.

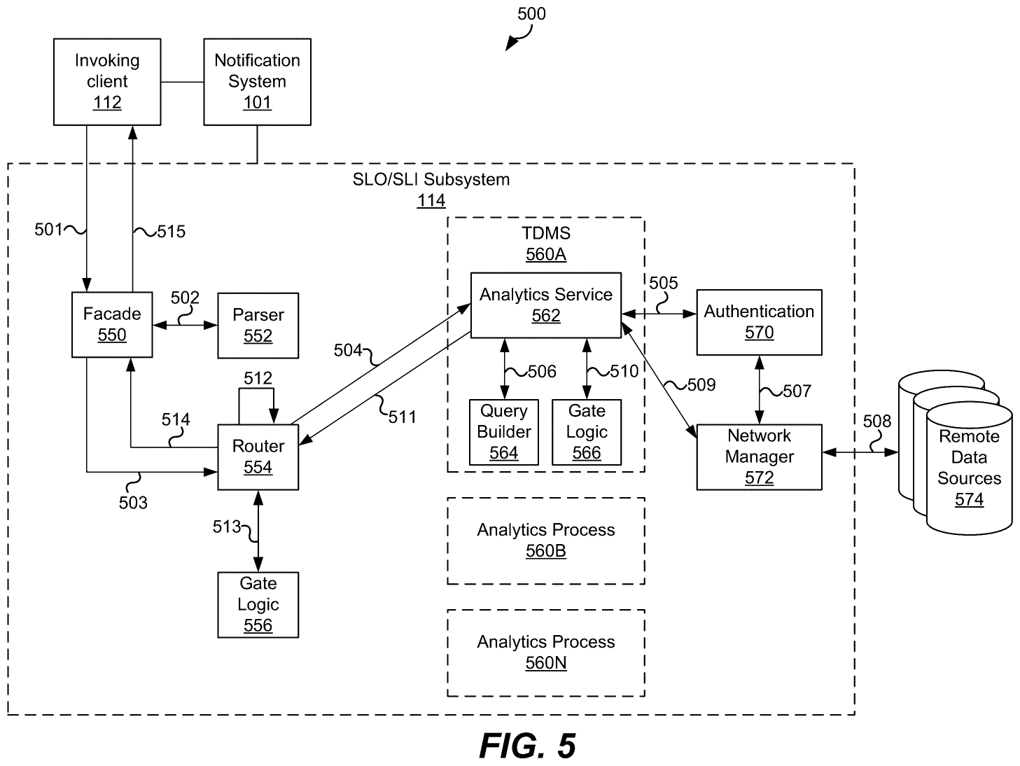

At 220, the invoking client computer system 112 and/or the SLO/SLI subsystem 114 may determine results of the automated performance test. For example, the SLO/SLI subsystem 114 may determine whether the expected Service Level (SLA) has been met by the completed performance tests. In other examples, the invoking client computer system 112, may execute SLO/SLI analysis immediately or later to determine whether the expected SLA has been met. In some examples, the invoking client computer system 112 and/or the SLO/SLI subsystem 114 may generate results by computing a binary decision such as pass/fail. To do so, the SLO/SLI subsystem 114 may make requests to obtain logs and metrics gathered during the performance test. For example, the SLO/SLI subsystem 114 may access the logs and metrics from the analytics and monitoring subsystem 150. A more detailed example of generating the results is described with reference to FIG. 5.

At 222, the control returns to the invoking PTS 122, which may post messages and notifications via the notification system 101. The messages may inform humans, devices, or other machine processes relating to completion of the performance test. The notification may include test results as measured from the performance testing tool and aggregated in files of the desirable format.

### Client-Side Load Balancing

Creating performance test scenarios that simulate real world use cases may be difficult at least in part because accounting for real-world user behaviors that impact load imposed on computer systems may vary. For example, in an e-commerce transaction processing platform, a user may log in to the system, browse product pages, add products into an electronic cart, access the checkout page, add a payment method, and complete a checkout. Each of these steps may involve the invocation and interaction with several application interface endpoints and multiple requests within the e-commerce transaction processing platform. However, a real user will also usually have time to think and make decisions-“think time.” In a real system, the above scenario would be applicable to several hundred, thousands, or more concurrent users, who may each be at different stages in the transaction flow and each have different “think times” from one another. Thus, it may be difficult to model real-world user behaviors, including think times, which may affect load imposed on computational systems at any given time. Furthermore, a certain number or percentage of users will drop-off and abandon their cart or just not complete a given part of the transaction flow.

Another issue that arises in multi-step transaction processes, such as for the e-commerce and other examples, is running the performance test to generate load (virtual users) that models the behavior expected for the performance test. Although a performance script can provide specific parameters, the issue is that on the client side, the performance test script must be aware of the dynamic load generation expectation from the specific client or server instance and how that load will be applied across each of the steps, usually referred to as thread groups.

The dynamic clusters 130 are used to test a load imposed by users such as the hypothetical e-commerce users. Each dynamic cluster 130 is autonomous with respect to one another and operates concurrently with other numbers of dynamic clusters 130, subject to infrastructure limitations. When a dynamic cluster 130 is created by the invocation a PTS 122, the components (dynamic client and/or dynamic server) of the dynamic cluster 130 each execute their initialization steps and attain a stable state to be ready to execute performance test orchestration when it receives the appropriate request and payload. As part of the initialization steps, each client in the dynamic cluster 130 makes calls to the config server 148 to retrieve the repository containing the performance scripts, configurations, and any other required metadata. On completion, control returns to the invoking PTS 122, with the necessary information to make further invocations to the cluster.

The PTS 122 makes the performance test invocation, providing the request and payload, through the underlying orchestration platform, to execute specific performance test scripts, which at this point are in the local repository of each component. If the dynamic cluster 130 includes a single dynamic client, the dynamic client loads the specified test and begins to execute the test. If the dynamic cluster 130 is a client-server cluster, each dynamic server component will retrieve the performance test script and proceed in the same way as though it were a single instance and unaware of any other dynamic servers in the cluster. However, each dynamic server communicates with the dynamic client, which aggregates the results of the performance test. However, since each dynamic server or dynamic client is executing the same performance script and same load, assuming a load generation requirement of 500 concurrent users, this will produce 1000 concurrent users, which is higher than the test requirement. Another issue is that the underlying infrastructure may not support 1000 concurrent users. Next, consider the test duration component where the test may be expected to run for 30 minutes. The performance test results produced will not only fail to meet the test goals or match real life traffic platform traffic to be tested, but the results will most likely produce errors that are likely to exceed the acceptable error thresholds due to the inability of the underlying infrastructure to generate and sustain the load and capture the results of the traffic caused by the incorrect performance test setup and execution.

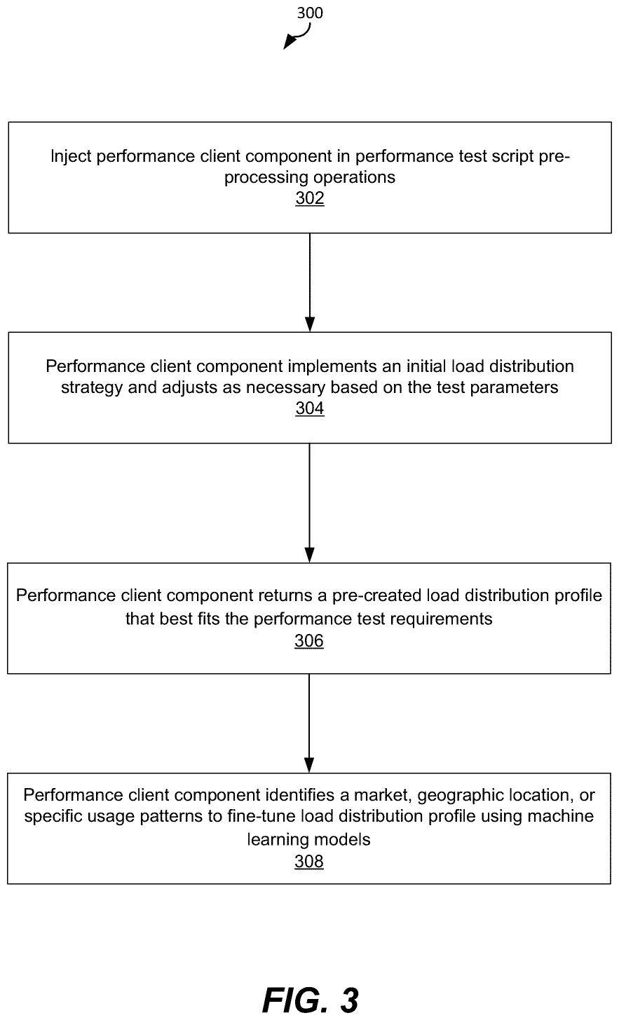

FIG. 3 illustrates an example of a method 300 of client-side load balancing. The method 300 may include decomposing the original test parameters across a sequence of user interactions and web requests to the target test system in such a way that replicates the user's actual real-world experience and matches the load distribution configurations.

At 302, a performance client component may be injected in the performance test script pre-processing operations, which have access to the configurations provided by the invocation which initiated the performance test execution. The performance client component may include instructions to determine load distribution profile.

At 304, the performance client component may implement an initial load distribution strategy. The performance client component may make calls to the PTS 122 to retrieve a more specific load distribution profile for the specific performance test based on the test parameters.

At 306, the performance client component may return a pre-created load distribution profile that fits the performance test requirements, so that for any virtual user configuration, the distribution profile returned from the different PTSs 122 may be different.

At 308, to improve accuracy and model real-time conditions, the performance client component may identify a market, geographic location, or specific usage patterns to fine-tune load distribution profile using machine learning models. For example, the performance client component may retrieve data from machine learning models that are tuned to different markets, geographic locations, or specific usage patterns (such as shopping patterns) at the time of the year. These models may predict load conditions based on various parameters such as the market, geographic location, or specific usage patterns over time. In this way, the performance client component may take into account these and other parameters that may cause the load distribution to change over time. In situations where performance testing is well-targeted, the performance client component may instantiate the dynamic clusters 130 in a geographic region that enables the impact of the general network/communication infrastructure to be factored into the analysis of the performance test results.

### Determining Testing Capacity

Executing automated performance testing over-capacity may result in error rates that exceed acceptable error limits. Over-capacity may refer to the performance test using computational resource in excess of what the computational resources allocated for the performant test can handle. Such over-capacity may therefore invalidate performance test results, resulting in wasted time and compute resources. Furthermore, in a containerized environment such as in the runtime environment 120, multiple containers such as the dynamic clusters 130 may be assigned to the same underlying virtual machine or physical server. This assignment may distort the quality of the load generation. This is because execution of multiple performance client containers on the same virtual machine implies the load generation is multiplied by the number of such instances, which may exceed the machine limits or approach its limits in such a way to cause a drift in the load generation.

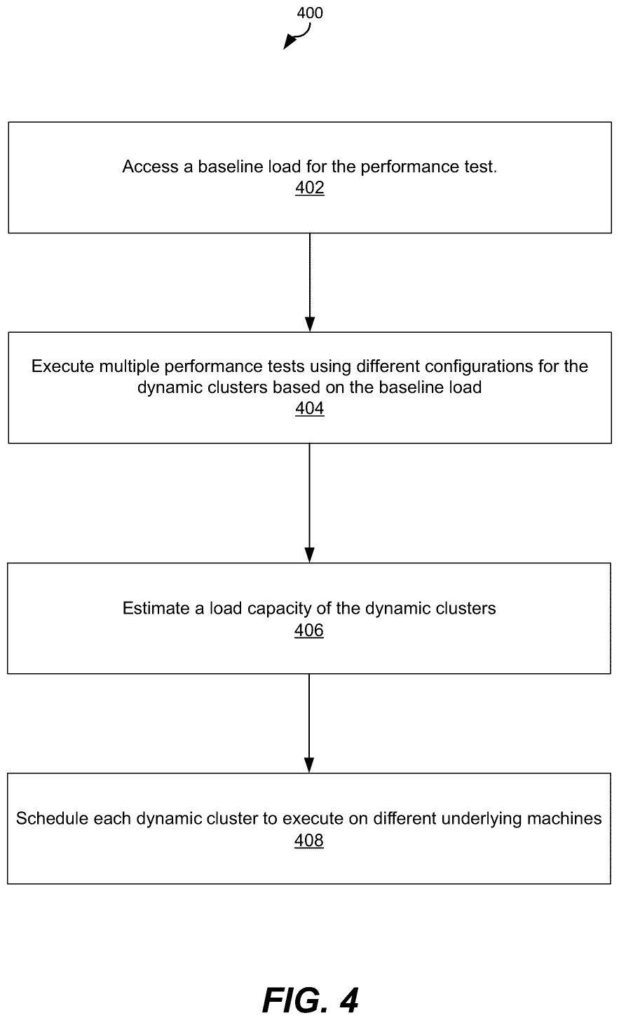

FIG. 4 illustrates an example method 400 of determining testing capacity of dynamic clusters 130 to prevent or reduce performance testing over-capacity. At 402, the PTS 122 may use a baseline load (such as number of virtual users). In some examples, the PTS 122 may use open-source tools such as APACHE JMETER that may recommend a benchmark load based on its testing.

Regardless of which baseline is used, at 404, the PTS 122 may execute multiple performance tests using different configurations for the dynamic clusters 130. Such baseline loads may be different for different types of performance tests and/or different durations of the tests. For example, a first baseline load may be used and adjusted for load tests, a second baseline load may be used and adjusted for stress tests, a third baseline load may be used and adjusted for soak tests, and/or other baseline loads may be used and adjusted for other types of performance tests. In particular, a certain load generation capacity may be ideal for load tests running for 10 minutes, but insufficient for a soak test running for 8 hours, resulting in error rates exceeding the acceptable error limits.

At 406, the PTS 122 estimate a testing capacity of the dynamic clusters 130. For example, the PTS 122 may increase the load and/or duration of the tested load on the dynamic clusters 130 until an error rate exceeds an acceptable error limit. Such error rate and error limits may be configured by a developer or other process. An acceptable error limit may be specified according to particular needs but may include a maximum duration of performing an operation in association with the tested load (such as a test process must complete within the maximum duration). Other error limits may be configured and used depending on the particular type of performance test being evaluated for estimating the testing capacity of the dynamic clusters 130.

At 408, after estimating the testing capacity for each dynamic cluster 130, the PTS 122 may schedule the one or more dynamic clusters 130 in such a way that each dynamic cluster 130 executes on different underlying machines. The PTS 122 may do so by tuning the request to schedule the performance test on different machines with specific labels, so that dynamic clients and/or dynamic servers cannot be on a single machine. When the created cluster information is returned, the PTS 122 inspects the configurations, validates it, and removes any server instance not meeting the requirements from participating in the performance test session. If a server machine is removed from the cluster, the PTS 122 refines its capacity calculations, adjusting the load generation per dynamic cluster 130 before initiating the execution of a performance test. The capacity determinations ensure that the dynamic clusters 130 will only generate load within the capacity limits of the underlying platform and can tolerate load overages within configured limits.

### System for Deciding/Finalizing Test Results

FIG. 5 illustrates an example of a data flow 500 of an SLO/SLI subsystem 114 for analyzing and determining the quality of the results of a performance test. Features of FIG. 1 will be referenced in the discussion of the data flow 500 that follows. The data flow 500 executes following completion of a performance test execution session.

At 501, the invoking client computer system 112 initiates the service level objectives/service level indicators analysis by providing a payload that includes information about the completed test session using a unique set of identifiers. This may include a global unique identifier as well as specific test and environment identifying information that allows the test results to be retrieved from a distributed network environment. At 502, the façade 550, which serves as an interface to receive the payload and interacts with a parser 552, decomposes the payload and analyze its constituent parts. The payload may include a data set comprising granular details about the payload that the parser 552 analyzes. The parser 552 may identify and return, to the façade 550, unique sub-payloads that are bound together and correlated within the network environment.

At 503, the façade 550 may forward the sub-payloads individually to a router 554. At 504, the router 554 routes requests to different Target Data Management Systems (TDMS) 560 (illustrated as TDMA 560A-N) in the SLO/SLI subsystem 114. Each TDMS 560 may monitor and provide different metrics relating to the automated performance test. For example, a first TDMS 560 may generate and store log files relating to performance of a target system 142 during the automated performance test, a second TDMS 560 may generate and store metrics relating to network performance in the target system 142 during the automated performance test, and/or another TDMS 560 may generate and store other data relating to the automated performance test. It should be noted that only TDMS 560A is shown in detail for clarity and TDMS 560B,N are shown in dashed line and may represent other numbers of instances of the system. However, the discussion with respect to TDMS 560A is also applicable to TDMS 560B,N but is omitted for clarity. For example, although not shown by lines, the router 554 transmits requests to the TDMS 560B,N and/or other TDMS 560. Likewise, functionality relating to activity of the TDMS 560 is shown only for TDMS 560A for clarity. It should be noted that operations of TDMS 560A may also be performed by TDMS 560B,N and/or other TDMS 560.

Each TDMS 560 may include an analytics service 562 (only TDMS 560A is shown in detail). At 506, a query builder 564 specific to each analytics service 562 may create appropriately formed requests with the payloads for each remote data systems and using additional supporting objects may authenticate and receive the authorization (shown at 505) to exchange traffic with the remote data sources 574 via a network manager 572 (shown at 507) and handle any required communication functions. Each of the interaction sessions with the remote data sources 574 is concurrent and executes as a separate process. The data from the remote data sources 574 may be time-series based data or any suitable result set. At 508, the remote data sources 574 may return the result set via the network manager 572 to the analytics service 562. At 509, the analytics service 562 may process the result set and any errors. At 510, the analytics service 562 may pass the result of processing, including any errors, to the attached gate logic 566, which is able to analyze the SLIs and compute a decision based on the SLOs for each sub-component of the overall request.

For each result set, a gating decision is made and computed to a decision based on the specified configuration objects and the gating logic handling for the performance results. The decision may include a binary decision such as pass/fail. At 511, the result of each sub-decision is then returned to the router 554. At 512, the router 554 arranges the result set and each gating sub-decision, and then passes the aggregate result set to a gate logic 556. At 513, the gate logic 556 may evaluate the sub-decisions and factors in custom rules to assign an overall gating decision for the performance results. The overall gating decision may be a binary decision such as pass/fail. The gate logic 556 may use a strict decisioning mode, a basic decisioning mode, a hybrid decisioning mode, and/or overall decision logic. In the strict decisioning mode, a failure result in any sub-decision will result in an overall ‘fail’ gating decision. In the basic decisioning mode, decisions are relaxed subject to achievement of certain benchmarks in which a single failure in a sub-decision may not result in an overall ‘fail’ gating decision. In the hybrid decisioning mode, the overall gating decision is based on multiple custom rules, each assigned specific weights and a threshold must be reached to result in a passing result. Otherwise, the overall gating decision results in a failure result.

At 514, after the overall gating decision is made, the entire result set is packaged with the original request and other related metadata and sent as a response via the façade 550. At 515, the façade 550 forwards the response to the invoking client computer system 112. Notifications and updates may be provided via the notification system 101 or other messaging channels.

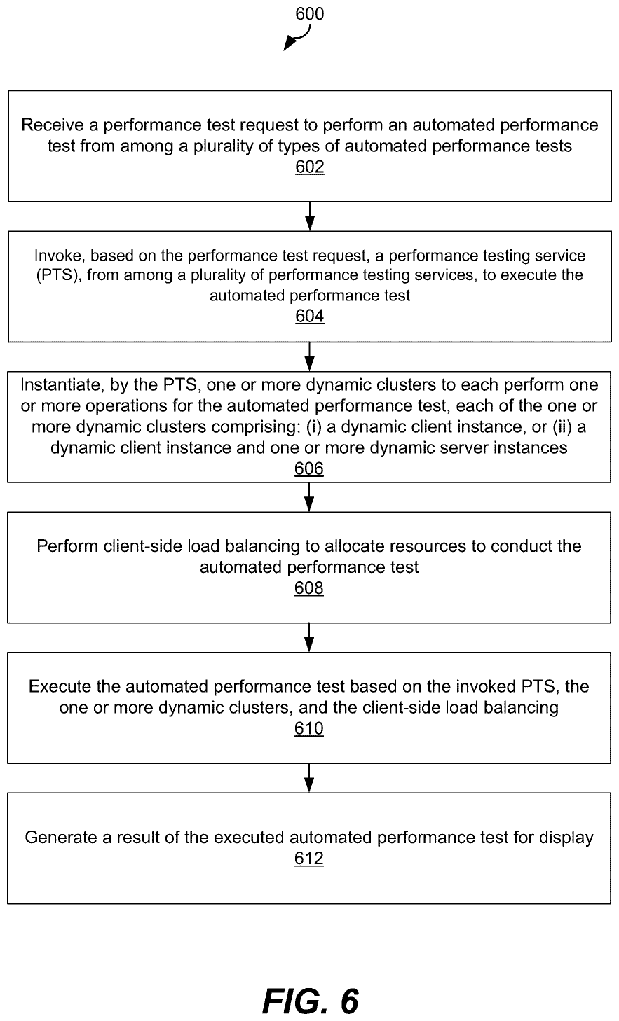

FIG. 6 illustrates an example of a method 600 of automated performance testing. At 602, the method 600 may include receiving a performance test request to perform an automated performance test from among a plurality of types of automated performance tests. Each type of automated performance test from among the plurality of automated performance tests being executed by a corresponding PTS, such as a PTS 122 illustrated in FIG. 1.

At 604, the method 600 may include invoking, based on the performance test request, a PTS, from among a plurality of PTSs, to execute the automated performance test.

At 606, the method 600 may include instantiating one or more dynamic clusters 130 to each perform one or more operations for the automated performance test. Each of the one or more dynamic clusters 130 comprising: (i) a dynamic client instance, or (ii) a dynamic client instance and one or more dynamic server instances. In some examples, the method 600 may include estimating a testing capacity for each dynamic cluster and instantiating the dynamic clusters based on the estimated load capacities. An example of estimating the testing capacity is described in FIG. 4.

At 608, the method 600 may include performing client-side load balancing to allocate resources to conduct the automated performance test. An example of client-side load balancing is described in FIG. 3.

At 610, the method 600 may include executing the automated performance test based on the invoked PTS, the one or more dynamic clusters, and the client-side load balancing.

At 612, the method 600 may include generating a result of the executed automated performance test for display. The result may include a binary result, such as a pass/fail of the performance test. An example of generating the result is described in FIG. 5.

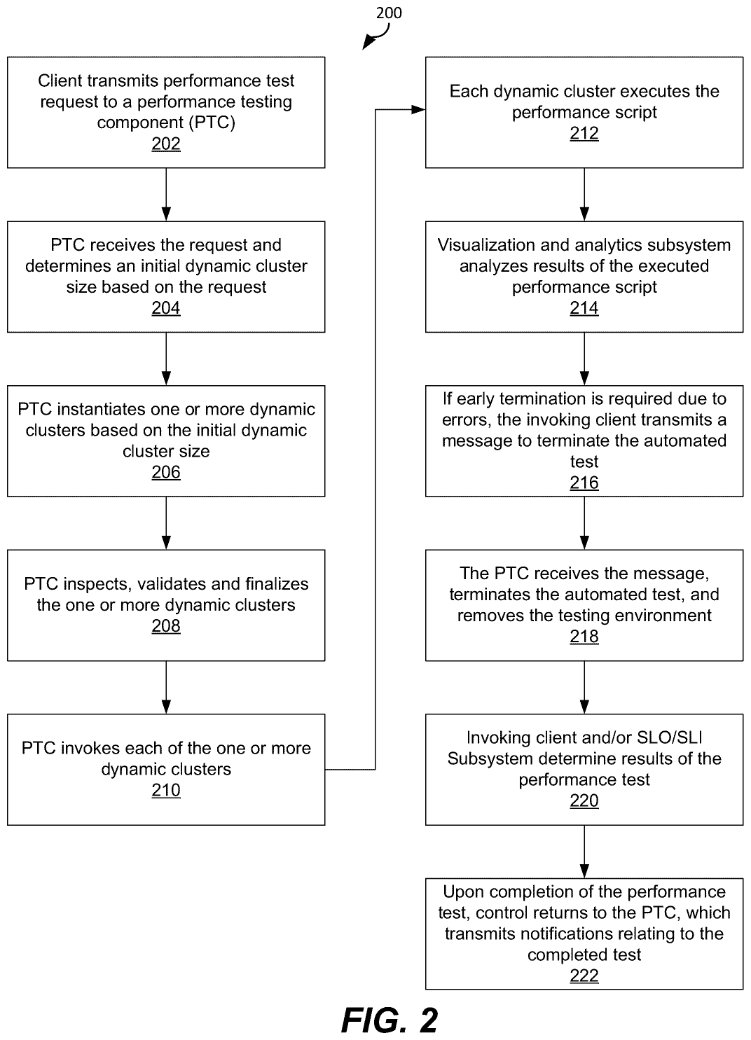

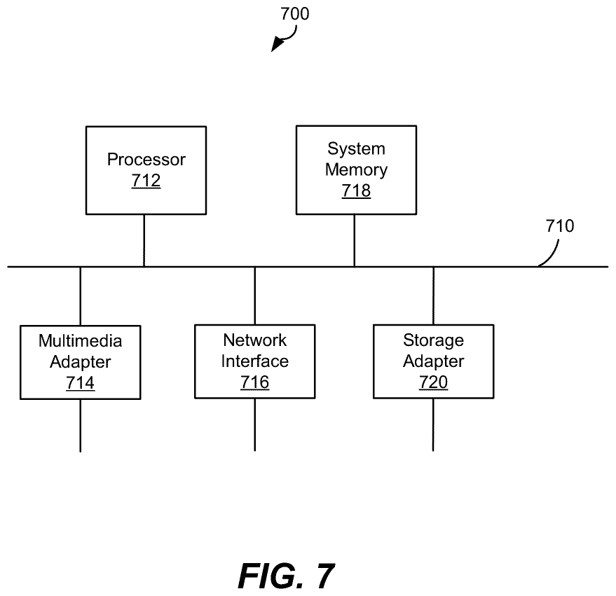

FIG. 7 illustrates an example of a computer system 700 that may implement the various features of FIGS. 1-6. The computer system 700 may be part of or include the system 100 to perform the functions and features described herein. For example, various ones of the devices of system 100 may be implemented based on some or all of the computer system 700.

The computer system 700 may include, among other things, an interconnect 710, a processor 712, a multimedia adapter 714, a network interface 716, a system memory 718, and a storage adapter 720. The interconnect 710 may interconnect various subsystems, elements, and/or components of the computer system 700. As shown, the interconnect 710 may be an abstraction that may represent any one or more separate physical buses, point-to-point connections, or both, connected by appropriate bridges, adapters, or controllers. In some examples, the interconnect 710 may include a system bus, a peripheral component interconnect (PCI) bus or PCI-Express bus, a HyperTransport or industry standard architecture (ISA) bus, a small computer system interface (SCSI) bus, a universal serial bus (USB), IIC (12C) bus, or an Institute of Electrical and Electronics Engineers (IEEE) standard 1364 bus, or “firewire,” or other similar interconnection element.

In some examples, the interconnect 710 may allow data communication between the processor 712 and system memory 718, which may include read-only memory (ROM) or flash memory (neither shown), and random-access memory (RAM) (not shown). It should be appreciated that the RAM may be the main memory into which an operating system and various application programs may be loaded. The ROM or flash memory may contain, among other code, the Basic Input-Output system (BIOS) which controls basic hardware operation such as the interaction with one or more peripheral components.

The processor 712 may control operations of the computer system 700. In some examples, the processor 712 may do so by executing instructions such as software or firmware stored in system memory 718 or other data via the storage adapter 720. In some examples, the processor 712 may be, or may include, one or more programmable general-purpose or special-purpose microprocessors, digital signal processors (DSPs), programmable controllers, application specific integrated circuits (ASICs), programmable logic device (PLDs), trust platform modules (TPMs), field-programmable gate arrays (FPGAs), other processing circuits, or a combination of these and other devices.

The multimedia adapter 714 may connect to various multimedia elements or peripherals. These may include devices associated with visual (e.g., video card or display), audio (e.g., sound card or speakers), and/or various input/output interfaces (e.g., mouse, keyboard, touchscreen). The network interface 716 may provide the computer system 700 with an ability to communicate with a variety of remote devices over a network. The network interface 716 may include, for example, an Ethernet adapter, a Fibre Channel adapter, and/or other wired- or wireless-enabled adapter. The network interface 716 may provide a direct or indirect connection from one network element to another and facilitate communication and between various network elements. The storage adapter 720 may connect to a standard computer readable medium for storage and/or retrieval of information, such as a fixed disk drive (internal or external).

Other devices, components, elements, or subsystems (not illustrated) may be connected in a similar manner to the interconnect 710 or via a network. The devices and subsystems can be interconnected in different ways from that shown in FIG. 6. Instructions to implement various examples and implementations described herein may be stored in computer-readable storage media such as one or more of system memory 718 or other storage. Instructions to implement the present disclosure may also be received via one or more interfaces and stored in memory. The operating system provided on computer system 700 may be MS-DOS®, MS-WINDOWS®, OS/2®, OS X®, IOS®, ANDROID®, UNIX®, Linux®, or another operating system.

The components of the system 100 illustrated in FIG. 1 may be connected to one another via a communication network (not illustrated), which may include the Internet, an intranet, a PAN (Personal Area Network), a LAN (Local Area Network), a WAN (Wide Area Network), a SAN (Storage Area Network), a MAN (Metropolitan Area Network), a wireless network, a cellular communications network, a Public Switched Telephone Network, and/or other network through which system 100 components may communicate.

The datastores described herein may be, include, or interface to, for example, an Oracle™ relational database sold commercially by Oracle Corporation. Other databases, such as PROMETHEUS, INFLUX DB, MYSQL, Informix™, DB2 or other data storage, including file-based, or query formats, platforms, or resources such as OLAP (On Line Analytical Processing), SQL (Structured Query Language), a SAN (storage area network), Microsoft Access™ or others may also be used, incorporated, or accessed. The database may comprise one or more such databases that reside in one or more physical devices and in one or more physical locations. The database may include cloud-based storage solutions. The database may store a plurality of types of data and/or files and associated data or file descriptions, administrative information, or any other data. The various databases may store predefined and/or customized data described herein.

Throughout the disclosure, the terms “a” and “an” may be intended to denote at least one of a particular element. As used herein, the term “includes” means includes but not limited to, the term “including” means including but not limited to. The term “based on” means based at least in part on. In the Figures, the use of the letter “N” to denote plurality in reference symbols is not intended to refer to a particular number. For example, “130A, B, N” and 130A-N do not refer to three examples of 130, but rather “two or more.”

The systems and processes are not limited to the specific embodiments described herein. In addition, components of each system and each process can be practiced independent and separate from other components and processes described herein. Each component and process also can be used in combination with other assembly packages and processes. The flow charts and descriptions thereof herein should not be understood to prescribe a fixed order of performing the method blocks described therein. Rather the method blocks may be performed in any order that is practicable including simultaneous performance of at least some method blocks. Furthermore, each of the methods may be performed by one or more of the system components illustrated in FIG. 1.

As will be appreciated based on the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. Example computer-readable media may be, but are not limited to, a flash memory drive, digital versatile disc (DVD), compact disc (CD), fixed (hard) drive, diskette, optical disk, magnetic tape, semiconductor memory such as read-only memory (ROM), and/or any transmitting/receiving medium such as the Internet or other communication network or link. By way of example and not limitation, computer-readable media comprise computer-readable storage media and communication media. Computer-readable storage media are tangible and non-transitory and store information such as computer-readable instructions, data structures, program modules, and other data. Communication media, in contrast, typically embody computer-readable instructions, data structures, program modules, or other data in a transitory modulated signal such as a carrier wave or other transport mechanism and include any information delivery media. Combinations of any of the above are also included in the scope of computer-readable media. The article of manufacture containing the computer code may be made and/or used by executing the code directly from one medium, by copying the code from one medium to another medium, or by transmitting the code over a network.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A system for automated performance test orchestration in a containerized environment, comprising:
one or more processors programmed to:
receive a performance test request to perform an automated performance test from among a plurality of types of automated performance tests, each type of automated performance test from among the plurality of automated performance tests being executed by a corresponding PTS (PTS);
invoke, based on the performance test request, a PTS, from among a plurality of PTSs, to execute the automated performance test;
instantiate, by the PTS, one or more dynamic clusters to each perform one or more operations for the automated performance test, each of the one or more dynamic clusters comprising: (i) a dynamic client instance, or (ii) a dynamic client instance and one or more dynamic server instances;
perform client-side load balancing to allocate resources to conduct the automated performance test;
execute the automated performance test based on the invoked PTS, the one or more dynamic clusters, and the client-side load balancing; and
generate a result of the executed automated performance test for display.

2. The system of claim 1, wherein the one or more processors are further programmed to:
access a baseline performance of the one or more dynamic clusters for the type of the automated performance test; and
estimate a testing capacity for each of the one or more dynamic clusters to execute the automated performance test based on the baseline performance, wherein the automated performance test is executed based further on the testing capacity.

3. The system of claim 2, wherein the one or more processors are further programmed to:
schedule a first dynamic cluster, from among the one or more dynamic clusters, to run on a first underlying virtual or physical machine; and
schedule a second dynamic cluster, from among the one or more dynamic clusters, to run on a second underlying virtual or physical machine.

4. The system of claim 1, wherein to invoke the PTS, the one or more processors are further programmed to:
identify the PTS to invoke based on an identification of the PTS specified by the performance test request.

5. The system of claim 1, wherein the performance test request comprises one or more requirements for the automated performance test, and wherein to invoke the PTS, the one or more processors are further programmed to:
determine, based on the one or more requirements, an intent of the performance test request without an express identification of the PTS to invoke; and
identify the PTS to invoke based on the determined intent.

6. The system of claim 5, wherein to determine the intent, the one or more processors are further programmed to:
match the one or more requirements with a functionality of the type of automated performance test that is to be executed; and
determine that the PTS provides the matched functionality, wherein the PTS is identified based on the determination.

7. The system of claim 5, wherein the one or more processors are further programmed to:
transmit, to a second PTS, based on the performance test request, a request to initiate the automated performance test;
determine, by the second PTS, that the PTS is to be invoked based on the intent; and
invoke, by the second PTS, the PTS.

8. The system of claim 1, wherein to perform client-side load balancing, the one or more processors are further programmed to:
identify a specific load distribution profile based on the type of the automated performance test, wherein the specific load distribution profile is based on real-world usage patterns.

9. The system of claim 1, wherein the one or more processors are further programmed to:
access first data from a first target data management system (TDMS);
access second data from a second TDMS;
aggregate the first data and the second data;
determine one or more service level indicates based on the aggregated first data and the second data; and
determine whether one or more service level objectives have been met based on the one or more service level indicators.

10. The system of claim 1, wherein the PTS comprises a microservice that instantiates each of the one or more dynamic clusters within a respective container in the containerized environment.

11. The system of claim 1, wherein the performance test request is received via an performance test Application Programming Interface call.

12. A method, comprising:
receiving, by one or more processors, a performance test request to perform an automated performance test from among a plurality of types of automated performance tests, each type of automated performance test from among the plurality of automated performance tests being executed by a corresponding PTS (PTS);
invoking, by one or more processors, based on the performance test request, a PTS, from among a plurality of PTSs, to execute the automated performance test;
instantiating, by one or more processors, at the PTS, one or more dynamic clusters to each perform one or more operations for the automated performance test, each of the one or more dynamic clusters comprising: (i) a dynamic client instance, or (ii) a dynamic client instance and one or more dynamic server instances;
performing, by one or more processors, client-side load balancing to allocate resources to conduct the automated performance test;
executing, by one or more processors, the automated performance test based on the invoked PTS, the one or more dynamic clusters, and the client-side load balancing; and
generating, by one or more processors, a result of the executed automated performance test for display.

13. The method of claim 12, further comprising:
accessing a baseline performance of the one or more dynamic clusters for the type of the automated performance test; and
estimating a testing capacity for each of the one or more dynamic clusters to execute the automated performance test based on the baseline performance, wherein the automated performance test is executed based further on the testing capacity.

14. The method of claim 12, wherein invoking the PTS comprises:
identifying the PTS to invoke based on an identification of the PTS specified by the performance test request.

15. The method of claim 12, wherein the performance test request comprises one or more requirements for the automated performance test, and wherein invoking the PTS comprises:
determining, based on the one or more requirements, an intent of the performance test request without an express identification of the PTS to invoke; and
identifying the PTS to invoke based on the determined intent.

16. The method of claim 15, wherein determining the intent comprises:
matching the one or more requirements with a functionality of the type of automated performance test that is to be executed; and
determining that the PTS provides the matched functionality, wherein the PTS is identified based on the determination.

17. The method of claim 15, further comprising:
transmitting, to a second PTS, based on the performance test request, a request to initiate the automated performance test;
determining, by the second PTS, that the PTS is to be invoked based on the intent; and
invoking, by the second PTS, the PTS.

18. The method of claim 12, wherein performing client-side load balancing comprises:
identifying a specific load distribution profile based on the type of the automated performance test, wherein the specific load distribution profile is based on real-world usage patterns.

19. The method of claim 12, further comprising:
accessing first data from a first target data management system (TDMS);
accessing second data from a second TDMS;
aggregating the first data and the second data;
determining one or more service level indicates based on the aggregated first data and the second data; and
determining whether one or more service level objectives have been met based on the one or more service level indicators.

20. A computer readable medium storing instructions that, when executed by one or more processors, program the one or more processors to:
receive a performance test request to perform an automated performance test from among a plurality of types of automated performance tests, each type of automated performance test from among the plurality of automated performance tests being executed by a corresponding PTS (PTS);
invoke, based on the performance test request, a PTS, from among a plurality of PTSs, to execute the automated performance test;
instantiate, by the PTS, one or more dynamic clusters to each perform one or more operations for the automated performance test, each of the one or more dynamic clusters comprising: (i) a dynamic client instance, or (ii) a dynamic client instance and one or more dynamic server instances;
perform client-side load balancing to allocate resources to conduct the automated performance test;
execute the automated performance test based on the invoked PTS, the one or more dynamic clusters, and the client-side load balancing; and
generate a result of the executed automated performance test for display.
